(19) United States
(12) Patent Application Publication
(10) Pub. No.: US 2018/0123138 A1
(43) Pub. Date: May 3, 2018

(54) HIGH PERFORMANCE TRANSITION METAL-DOPED Pt-Ni CATALYSTS

(71) Applicant: THE REGENTS OF THE UNIVERSITY OF CALIFORNIA, Oakland, CA (US)

(72) Inventors: Yu HUANG, Los Angeles, CA (US); Xiangfeng DUAN, Los Angeles, CA (US); Xiaoqing HUANG, Los Angeles, CA (US); Zipeng ZHAO, Los Angeles, CA (US)

(73) Assignee: THE REGENTS OF THE UNIVERSITY OF CALIFORNIA, Oakland, CA (US)

(21) Appl. No.: 15/566,194

(22) PCT Filed: Apr. 13, 2016
(86) PCT No.: PCT/US2016/027295

§ 371 Date: Oct. 12, 2017

Related U.S. Application Data
(60) Provisional application No. 62/146,803, filed on Apr. 13, 2015.

(51) Int. Cl. H01M 4/92; H01M 12/08; H01M 8/1039

(52) U.S. Cl. CPC H01M 4/921; H01M 12/08; H01M 2008/1095; H01M 4/926; H01M 8/1039

(57) ABSTRACT

An electrode material includes a catalyst support and Pt—Ni nanostructures affixed to the catalyst support. The Pt—Ni nanostructures are doped with at least one dopant M.

### CROSS-REFERENCE TO RELATED APPLICATION

This application claims the benefit of U.S. Provisional Application Ser. No. 62/146,803, filed on Apr. 13, 2015, the content of which is incorporated herein by reference in its entirety.

### STATEMENT REGARDING FEDERALLY SPONSORED RESEARCH OR DEVELOPMENT

This invention was made with Government support under W911NF-09-1-0433, awarded by the U.S. Army, Army Research Office. The Government has certain rights in the invention.

### TECHNICAL FIELD

This disclosure generally relates to electrocatalysts and, more particularly, to transition metal-doped platinum-based catalysts.

### BACKGROUND

Proton-exchange membrane (PEM) fuel cells are desirable energy conversion devices for applications such as transportation vehicles and portable electronic devices, due to their high-energy density and low environmental impact in addition to being light-weight and affording low-temperature operation. PEM fuel cells operate based on reactions of a fuel (such as hydrogen or an alcohol) at an anode and an oxidant (molecular oxygen) at a cathode. Both cathode and anode reactions include catalysts to lower their electrochemical over-potential for high-voltage output, and so far, platinum (Pt) has been the leading choice. To fully realize the commercial viability of fuel cells, the following challenges should be addressed: the high cost of Pt, the sluggish kinetics of the oxygen reduction reaction (ORR), and the low durability of Pt-based catalysts.

It is against this background that a need arose to develop the embodiments described herein.

### SUMMARY

Alloying Pt with a secondary metal reduces the usage of scarce Pt metal while at the same time provides improved performance as compared with that of pure Pt in terms of activity. In particular, bimetallic platinum-nickel (Pt—Ni) nanostructures represent a class of electrocatalysts for ORR in fuel cells, but practical applications have been constrained by catalytic activity and durability. Although an increase in ORR activity is observed for Pt—Ni nanostructures, the activity as observed on bulk Pt₃Ni(111) surface has not been matched, indicating room for further improvement. At the same time, a notable constraint of Pt—Ni nanostructures is their low durability. The Ni element in these nanostructures leaches away gradually under detrimental corrosive ORR conditions, resulting in rapid performance losses. Thus, Pt-based nanostructures with simultaneously high catalytic activity and high durability have remained a challenge.

Some embodiments of this disclosure are directed to surface-doped Pt₃Ni nanostructures in the form octahedra supported on carbon, with dopants corresponding to transition metals, termed M-Pt₃Ni/C, where M is vanadium (V), chromium (Cr), manganese (Mn), iron (Fe), cobalt (Co), molybdenum (Mo), tungsten (W), or rhenium (Re). In some embodiments, Mo—Pt₃Ni/C exhibits particularly improved ORR performance, with a specific activity of about 10.3 mA/cm² (or greater) and a mass activity of about 6.98 A/mg_{Pt} (or greater), which are about 81- and 73-fold enhancements compared with a Pt/C catalyst (about 0.127 mA/cm² and about 0.096 A/mg_{Pt}). Without wishing to be bound by a particular theory, calculations indicate that Mo preferentially locates at subsurface positions near nanoparticle edges in vacuum and surface vertex/edge sites in oxidizing conditions, where Mo can enhance both the activity and the stability of the Pt₃Ni catalyst. The surface doping approach can be applied to the rational design of catalysts and other materials with enhanced activity and durability, for applications such as fuel cells, batteries and chemical production.

Other aspects and embodiments of this disclosure are also contemplated. The foregoing summary and the following detailed description are not meant to restrict this disclosure to any particular embodiment but are merely meant to describe some embodiments of this disclosure.

### BRIEF DESCRIPTION OF THE DRAWINGS

For a better understanding of the nature and objects of some embodiments of this disclosure, reference should be made to the following detailed description taken in conjunction with the accompanying drawings.

FIG. 1. Structure analyses for transition metal-doped Pt₃Ni/C catalysts. (A and B) Representative high-angle annular dark-field scanning transmission electron microscopy (HAADF-STEM) images of the (A) Pt₃Ni/C and (B) Mo—Pt₃Ni/C catalysts. (C and D) high-resolution TEM (HRTEM) images on individual octahedral (C) Pt₃Ni/C and (D) Mo—Pt₃Ni/C nanocrystals. (E and F) energy-dispersive x-ray spectroscopy (EDS) line-scanning profile across individual (E) Pt₃Ni/C and (F) Mo—Pt₃Ni/C octahedral nanocrystals. (G) Pt, Ni, and Mo x-ray photoelectron spectroscopy (XPS) spectra for the octahedral Mo—Pt3Ni/C catalyst.

FIG. 2. Electrocatalytic properties of high-performance transition metal-doped octahedral Pt₃Ni/C catalysts and a commercial Pt/C catalyst. (A) Cyclic voltammograms of octahedral Mo—Pt₃Ni/C, octahedral Pt₃Ni/C, and commercial Pt/C catalysts recorded at room temperature in N₂-purged about 0.1 M HClO₄ solution with a sweep rate of about 100 mV/s. (B) ORR polarization curves of octahedral Mo—Pt₃Ni/C, octahedral Pt₃Ni/C, and commercial Pt/C catalysts recorded at room temperature in an O₂-saturated about 0.1 M HClO₄ aqueous solution with a sweep rate of about 10 mV/s and a rotation rate of about 1600 rotations per min (rpm). (C) The electrochemically active surface area (ECSA, top), specific activity (middle), and mass activity (bottom) at about 0.9 V versus reversible hydrogen electrode (RHE) for these transition metal-doped Pt₃Ni/C catalysts, which are given as kinetic current densities normalized to the ECSA and the loading amount of Pt, respectively. In (A) and (B), current densities were normalized in reference to the geometric area of a rotating disk electrode (RDE) (about 0.196 cm²).

FIG. 3. Electrochemical durability of high-performance octahedral Mo—Pt₃NiCo/C catalyst and octahedral Pt₃Ni/C catalyst. (A and B) ORR polarization curves and (inset) corresponding cyclic voltammograms of (A) the octahedral Mo—Pt₃Ni/C catalyst and (B) the octahedral Pt₃Ni/C catalyst before, after 4000, and after 8000 potential cycles between about 0.6 and about 1.1 V versus RHE. (C) The changes of ECSAs (left), specific activities (middle), and mass activities (right) of the octahedral Mo—Pt₃Ni/C catalyst and octahedral Pt₃Ni/C catalyst before, after 4000, and after 8000 potential cycles. The durability tests were carried out at room temperature in O₂-saturated about 0.1 M HClO₄ at a scan rate of about 50 mV/s.

FIG. 4. Computational results. (A and B) The average site occupancies of the second layer of (A) Ni₁₁₇₅Pt₃₃₉₈ NC and (B) Mo₇₃Ni₁₁₄₃Pt₃₃₅₇ NC at about 170° C. as determined by a Monte Carlo simulation. Occupancies are indicated by the triangle on the right. Small spheres represent the atoms in the outer layer. (C) The calculated binding energies for a single oxygen atom on all face-centered cubic (fcc) and hexagonal close packed (hcp) sites on the (111) facet of Mo₆Ni₄₁Pt₁₇₈ NC, relative to the lowest binding energy. Light shaded spheres represent Pt, and dark shaded spheres represent oxygen sites. Three binding energies are provided for reference: the calculated binding energy on the fcc site of a pure Pt (111) surface, the binding energy corresponding to the peak of the Sabatier volcano, and the binding energy on a Pt₃Ni(111) surface. (D) The change in binding energies when Ni₄₇Pt₁₇₈ NC is transformed to Mo₆Ni₄₁Pt₁₇₈ NC by the substitution of Mo on its energetically favored sites in the second layer below the vertices.

FIG. 5 Schematic illustration of (A) an one-pot fabrication of highly dispersive octahedral Pt₃Ni/C catalyst and (B) the fabrication of various octahedral transition metal-doped Pt₃Ni/C catalysts.

FIG. 6. Representative (A and B) TEM and (C) HAADF-STEM images of octahedral Pt₃Ni/C catalyst. (D) Representative TEM image of the octahedral Mo—Pt₃Ni/C catalyst.

FIG. 7. Typical powder x-ray diffraction (PXRD) patterns for various transition metal-doped octahedral Pt₃Ni/C catalysts.

FIG. 8. Representative TEM images of (A and B) octahedral Pt₃Ni/C and (D and E) octahedral Mo—Pt₃Ni/C catalysts before (left panels) and after (middle panels) 8000 potential sweep cycles between about 0.6 and about 1.1 V versus RHE in an O₂-saturated about 0.1 NClO₄ solution at about 50 mV s−1. TEM-EDS spectra of (C) octahedral Pt₃Ni/C catalyst and (F) octahedral M-Pt₃Ni/C catalyst before and after 8000 potential sweep cycles.

FIG. 9. Representative TEM images for commercial Pt/C catalyst (Alfa Aesar, about 20 wt. % Pt, Pt particle size: about 2-5 nm).

FIG. 10. (A) CO stripping curves of octahedral Mo—Pt₃Ni/C, octahedral Pt₃Ni/C and commercial Pt/C catalysts recorded at room temperature in CO-saturated about 0.1 M HClO₄ solution. Scanning rate=about 50 mVs⁻¹. (B) The electrochemically active surface area (ECSA, up panel) and specific activity (bottom panel) at about 0.9 V versus RHE for transition metal-doped Pt₃Ni/C catalysts, which are given as kinetic current densities normalized to the ECSA calculating from the charge in CO stripping curves. The middle panel in (B) is the ratio between ECSA values determined by integrated charge from CO stripping (ECSACO) and deposited hydrogen (ECSAH). In (A), the current densities were normalized in reference to the geometric area of the RDE (about 0.196 cm²).

FIG. 11, Representative TEM images for various transition metal-doped octahedral Pt₃Ni/C catalysts: (A) octahedral V-Pt₃Ni/C catalyst, (B) octahedral Cr—Pt₃Ni/C catalyst, (C) octahedral Mn—Pt₃Ni/C catalyst, (D) octahedral Fe—Pt₃Ni/C catalyst, (E) octahedral Co—Pt₃Ni/C catalyst, (F) octahedral Mo—Pt₃Ni/C catalyst, (G) octahedral W—Pt₃Ni/C catalyst and (H) octahedral Re—Pt₃Ni/C catalyst. Representative HRTEM images for various transition metal-doped Pt₃Ni/C catalysts: (I) octahedral V—Pt₃Ni/C catalyst, (I) octahedral Cr—Pt₃Ni/C catalyst and (K) octahedral Co—Pt3Ni/C catalyst. (L) Line-scanning profile across an octahedral Co—Pt₃Ni/C nanocrystal, which is indicated in the inset of (L).

FIG. 12. XPS spectra of various transition metal-doped octahedral Pt₃Ni/C catalysts: (A) V—Pt₃Ni/C catalyst, (B) Cr—Pt₃Ni/C catalyst, (C) Mn—Pt₃Ni/C catalyst, (D) Fe—Pt₃Ni/C catalyst, (E) Co—Pt₃Ni/C catalyst, (F) Mo—Pt₃Ni/C catalyst, (G) W—Pt₃Ni/C catalyst and (H) Re—Pt₃Ni/C catalyst.

FIG. 13. Representative ORR polarization curves for various transition metal-doped octahedral Pt₃Ni/C catalysts recorded at room temperature in an O₂-saturated about 0.1 M HClO₄ aqueous solution with a sweep rate of about 10 mV/s and a rotation rate of about 1600 rpm: (A) Pt₃Ni/C catalyst, (B) V—Pt₃Ni/C catalyst, (C) Cr—Pt₃Ni/C catalyst, (D) Mn—Pt₃Ni/C catalyst, (E) Fe—Pt₃Ni/C catalyst, (F) Co—Pt₃Ni/C catalyst, (G) Mo—Pt₃Ni/C catalyst, (H) W—Pt₃Ni/C catalyst and (I) Re—Pt₃Ni/C catalyst. Insets show their corresponding cyclic voltammogram curves recorded at room temperature in N₂-purged about 0.1 M HClO₄ solution with a sweep rate of about 100 mV/s.

FIG. 14. Pt and Ni spectra for octahedral Pt₃Ni/C catalyst before (A) and after (B) 8000 potential sweep cycles. Pt, Ni and Mo XPS spectra for octahedral Mo—Pt₃Ni/C catalyst before (C) and after (D) 8000 potential sweep cycles. The Ni 2p and Pt 4f XPS spectra of Mo-doped Pt₃Ni/C catalyst show that the majority of the surface Ni was in the oxidized state and the surface Pt was mainly in the metallic state. Mo exhibits mainly Mo(6+) and Mo(4+) state, which showed Mo largely present in the form of MoOₓ on the surface in Mo—Pt₃Ni/C alloy nanoparticles.

FIG. 15. Average site occupancies of the (A) first, (B) second, and (C) third layers in the Ni₁₁₇₅N₃₃₉₈ nanoparticle and the (D) first, (E) second, and (F) third layers in the Mo₇₃Ni₁₁₄₃Pt₃₃₅₇ nanoparticle at 170° C., as determined by a Monte Carlo simulation. Designated spheres represent pure Pt, pure Ni, and pure Mo. Other shades represent fractional occupancies, as indicated by the triangle on the right. Small spheres represent the positions of atoms in the outer layers.

FIG. 16. STEM electron energy loss spectroscopy (STEM-EELS) analysis of as-synthesized Fe—Pt₃Ni/C octahedra. (A and D) STEM images of two different oriented Pt₃Ni nanoparticles. (B and E) Schematics of particle orientations corresponding to the respective STEM images. The arrows in (A, B, D and E) represent the EELS line scan directions. (C and F) EELS line scans indicate that the preferential locations of Fe atoms are at the edges/tips of octahedra for both particles (Fe—Pt₃Ni/C was chosen for EELS for its higher signal to noise ratio at this low concentration).

FIG. 17. The (A) first, (B) second, (C) third, and (D) fourth layers of a representative Ni₁₁₇₅Pt₃₃₉₈ nanoparticle taken from a Monte Carlo simulation at 170° C. Light shaded spheres represent Pt and dark shaded spheres represent Ni. Small spheres represent the positions of atoms in the outer layers.

FIG. 18. The (A) first, (B) second, and (C) third layers of the predicted ground state Mo₆Ni₄₁Pt₁₇₈ nanoparticle. Designated spheres represent Pt, Ni, and Mo. Small spheres represent the positions of atoms in the outer layers.

FIG. 19. The top five layers of the nine-layer Mo₂Ni₇Pt₂₇ slab. Designated spheres represent Pt, Ni, and Mo. The third and fourth layers are aligned so that the Ni atom is in the hollow site formed by three Pt atoms in the layer below it. The second layer is aligned so that the Mo atom falls in the hollow site formed by three Pt atoms in the third layer. The four bottom layers (not shown) symmetrically correspond to the four top layers.

FIG. 20. The relaxed structures used to calculate the stability of (A) one, (B) two, (C) and three oxygen atoms adsorbed on a Mo atom on the vertex of Mo₆Ni₄₁Pt₁₇₈. Designated spheres represent Pt, Mo, and oxygen.

FIG. 21. Schematic of a fuel cell according to an embodiment of this disclosure.

FIG. 22. Schematic of a metal-air battery according to an embodiment of this disclosure.

### DETAILED DESCRIPTION

Embodiments of this disclosure are directed to improved Pt-based electrocatalysts for ORR, exhibiting a combination of high activity and high stability. Some embodiments are directed to Pt—Ni nanostructures and, in particular, Pt₃Ni-based nanostructures because Pt₃Ni(111) surfaces can provide efficient catalysis for ORR. In some embodiments, challenges discussed above are addressed through a surface engineering approach based on control over dopant incorporation of various transition metals on surfaces of Pt₃Ni nanostructures in the form octahedra supported on carbon, termed M-Pt₃Ni/C, where M is V, Cr, Mn, Fe, Co, Mo, W, or Re. Owing to the efficient in-situ and bulky capping agent-free approach of some embodiments, the coupling of Pt₃Ni nanostructures to a carbon support can remain strong. A seed-mediated growth strategy and a relatively slow continuous surface dopant infusion can provide a desirable growth condition, leading to a well-maintained particle size distribution of surface-doped Pt₃Ni nanostructures. Resulting surface-doped Pt₃Ni nanostructures can exhibit impressive activity in ORR, and their activity can be dopant-dependent. Of note, the resulting surface-doped Pt₃Ni nanostructures can simultaneously satisfy an overall criteria of high specific activity, high mass activity, and suppressed degradation of performance. Without wishing to be bound by a particular theory, the presence of a transition metal dopant, such as an electropositive Mo in Mo—Pt₃Ni/C, can stabilize an alloy composition of the catalyst by inhibiting against dissolution and diffusion through formation of strong bonds with the transition metal dopant, such as strong Mo—Pt and Mo—Ni bonds, and can shift oxygen binding energies to promote enhanced catalytic activity.

In some embodiments, a Pt-based electrocatalyst is a doped intermetallic alloy of Pt and at least one secondary metal having a chemical composition that can be represented by the formula M_{z}—PtₓNi_{y}, where any one or any combination of two or more of the following applies: (1) Pt represents platinum as a primary metal; (2) Ni represents nickel as a secondary metal; (3) M represents at least one metal as a dopant and with M being different from Pt and Ni, such as where M is at least one transition metal selected from Group 3, Group 4, Group 5, Group 6, Group 7, Group 8, Group 9, Group 10, Group 11, and Group 12 of the Periodic Table and with M being different from Pt and Ni; (4) x represents a molar content of Pt, y represents a molar content of Ni, z represents a molar content of M, with x>y and x>z and also, in some embodiments, y>z; (5) x has a non-zero value in a range of about 51 to about 95, such as about 60 to about 90, about 68 to about 82, about 70 to about 78, or about 72 to about 76; (6) y has a non-zero value in a range of about 5 to about 49, such as about 10 to about 40, about 18 to about 32, about 20 to about 30, about 22 to about 28, or about 23 to about 27; (7) z has a non-zero value in a range of 0 to about 8, such as about 0.1 to about 8, about 0.5 to about 5, about 0.5 to about 3, or about 0.5 to about 2.5; and (8) subject to the condition that x+y+z=100 (or 100%).

In some embodiments, a ratio of x to y is about 3, and z has a non-zero value in a range of about 0.5 to about 3 or about 0.5 to about 2.5.

In some embodiments, M is at least one transition metal selected from Group 5, Group 6, Group 7, Group 8, and Group 9 of the Periodic Table. In some embodiments, M is one or more of V, Cr, Mn, Co, Mo, W, and Re. It is contemplated that a Pt-based electrocatalyst can be doped with combinations of two or more different doping elements, such as two or more transition metals selected from Group 3, Group 4, Group 5, Group 6, Group 7, Group 8, Group 9, Group 10, Group 11, and Group 12 of the Periodic Table, or two or more transition metals selected from V, Cr, Mn, Fe, Co, Mo, W, and Re. In the case of two or more doping elements, the ranges specified above for z can correspond to a combined molar content of the two or more doping elements.

It is also contemplated that a Pt-based electrocatalyst can include another secondary metal, generally termed M′, in place of, or in combination with, Ni. Other suitable secondary metals include transition metals selected from Group 3, Group 4, Group 5, Group 6, Group 7, Group 8, Group 9, Group 10, Group 11, and Group 12 of the Periodic Table. In the case of two or more secondary metals, the ranges specified above for y can correspond to a combined molar content of the two or more secondary metals. Also contemplated are combinations of Pt with one or more secondary metals in a manner other than, or in conjunction with, alloying, such as heterostructures which include a first phase and a second phase, where the phases are joined together or next to one another, and the first phase and the second phase have different chemical compositions.

In some embodiments, a Pt-based electrocatalyst includes multiple nanostructures having the above-noted chemical composition, where any one or any combination of two or more of the following applies: (1) the nanostructures have sizes (or have an average size) in a range of up to about 100 nm, up to about 50 nm, up to about 40 nm, up to about 30 nm, up to about 20 nm, up to about 15 nm, up to about 10 nm, up to about 9 nm, up to about 8 nm, up to about 7 nm, up to about 6 nm, up to about 5 nm, or up to about 4.5 nm, and down to about 4 nm, down to about 3.5 nm, or less; (2) the nanostructures have at least one dimension or extent (or have at least one average dimension or extent) in a range of up to about 100 nm, up to about 50 nm, up to about 40 nm, up to about 30 nm, up to about 20 nm, up to about 15 nm, up to about 10 nm, up to about 9 nm, up to about 8 nm, up to about 7 nm, up to about 6 nm, up to about 5 nm, or up to about 4.5 nm, and down to about 4 nm, down to about 3.5 nm, or less; (3) the nanostructures have aspect ratios (or have an average aspect ratio) in a range of up to about 3, such as about 1 to about 3, about 1 to about 2.5, about 1 to about 2, or about 1 to about 1.5, or in a range of greater than about 3, such as about 4 or greater, about 5 or greater, or about 10 or greater; and (4) the nanostructures are largely or substantially crystalline, such as with a percentage of crystallinity (by volume or weight) of at least about 50%, at least about 60%, at least about 70%, at least about 80%, at least about 90%, at least about 95%, at least about 98%, or at least about 99% or more. Nanostructures of a Pt-based electrocatalyst can have a variety of morphologies, such as in the form of octrahedra having exposed (111) facets, although other morphologies are encompassed by this disclosure, including nanoparticles, nanorods, nanowires, or other elongated nanostructures having aspect ratios greater than about 3, as well as core-shell nanostructures, core-multi-shell nanostructures, and nanoparticle-decorated cores, among others.

In some embodiments, a Pt-based electrocatalyst includes multiple nanostructures that are surface doped with M, such that at least a majority (e.g., by weight, moles, or number) of M atoms are located within a depth of 5 atomic layers from an exterior of a nanostructure, such as within 4 atomic layers, within 3 atomic layers, or within 2 atomic layers. In some embodiments, at least a majority (e.g., by weight, moles, or number) of M atoms are in an oxidized state.

In some embodiments, a Pt-based electrocatalyst includes multiple nanostructures that are loaded on, dispersed in, affixed to, anchored to, or otherwise connected to a catalyst support, such as carbon black. In place of, or in combination with, carbon black, another catalyst support having suitable electrical conductivity can be used, such as another carbon-based support in the form of carbon fiber paper or carbon cloth, as well as metallic foams, among others. A combination of a Pt-based electrocatalyst loaded on a catalyst support can be referred to as an electrode material.

In some embodiments, an electrochemically active surface area (EASA) of a Pt-based electrocatalyst loaded on a catalyst support can be at least about 55 m²/g_{Pt}, at least about 60 m²/g_{Pt}, at least about 63 m²/g_{Pt}, at least about 65 m²/g_{Pt}, or at least about 67 m²/g_{Pt}, and up to about 70 m²/g_{Pt}, up to about 75 m²/g_{Pt}, or up to about 78 m²/g_{Pt}, or more, based on hydrogen under-potential deposition (Hupd). In some embodiments, a specific activity of the Pt-based electrocatalyst can be at least about 0.5 mA/cm², at least about 1 mA/cm², at least about 2 mA/cm², at least about 3 mA/cm², at least about 4 mA/cm², at least about 5 mA/cm², at least about 6 mA/cm², at least about 7 mA/cm², at least about 8 mA/cm², at least about 9 mA/cm², or at least about 10 mA/cm², and up to about 10.3 mA/cm², up to about 10.5 mA/cm²or more, at about 0.9 V versus a reversible hydrogen electrode (RHE) and based on Hupd. In some embodiments, a mass activity of the Pt-based electrocatalyst can be at least about 0.2 A/mg_{Pt}, at least about 0.5 A/mg_{Pt}, at least about 1 A/mg_{Pt}, at least about 1.5 A/mg_{Pt}, at least about 2 A/mg_{Pt}, at least about 2.5 A/mg_{Pt}, at least about 3 A/mg_{Pt}, at least about 3.5 A/mg_{Pt}, at least about 4 A/mg_{Pt}, at least about 4.5 A/mg_{Pt}, at least about 5 A/mg_{Pt}, at least about 5.5 A/mg_{Pt}, at least about 6 A/mg_{Pt}, or at least about 6.5 A/mg_{Pt}, and up to about 7 A/mg_{Pt}, up to about 7.5 A/mg_{Pt}, or more, at about 0.9 V versus a RHE and based on Hupd. In some embodiments, at least about 75% of an initial specific or mass activity can be retained after 4000 potential cycles, such as at least about 80%, at least about 85%, at least about 90%, or at least about 95%, and up to about 97%, up to about 98%, or more, and at least about 70% of the initial specific or mass activity can be retained after 8000 potential cycles, such as at least about 75%, at least about 80%, at least about 85%, or at least about 90%, and up to about 95%, up to about 97%, or more, when cycled between about 0.6 V and about 1.1 V versus a RHE at a scan rate of about 50 mV/s.

In some embodiments, a Pt-based electrocatalyst can be formed according to a manufacturing method including: (1) providing a dispersion of Pt—Ni nanostructures affixed to a catalyst support in a liquid medium; and (2) reacting a M-containing precursor, a Pt-containing precursor, and a Ni-containing precursor in the liquid medium to form M-doped Pt—Ni nanostructures.

In some embodiments, providing the dispersion in (1) includes reacting a Pt-containing precursor (which can be the same as or different from the Pt-containing precursor used in (2)) and a Ni-containing precursor (which can be the same as or different from the Ni-containing precursor used in (2)) in the presence of the catalyst support in the liquid medium to form the dispersion of Pt—Ni nanostructures affixed to the catalyst support. Suitable Pt-containing precursors (used in (1) and (2)) include an organometallic coordination complex of Pt with an organic anion, such as acetylacetonate, and suitable Ni-containing precursors (used in (1) and (2)) include an organometallic coordination complex of Ni with an organic anion, such as acetylacetonate. The liquid medium includes one or more solvents, such as one or more organic solvents selected from polar aprotic solvents, polar protic solvents, and non-polar solvents. In some embodiments, a solvent included in the liquid medium also can serve as a reducing agent for reduction of Pt and Ni, although the inclusion of a separate reducing agent is also contemplated. In some embodiments, a structure-directing agent, such as benzoic acid or other aromatic carboxylic acid, is also included in the liquid medium to promote a desired morphology of Pt—Ni nanostructures. Multiple metal-containing precursors including secondary metals different from Pt can be used, such as to form alloys of Pt and two or more secondary metals. Reaction can be carried out under agitation and under conditions of a temperature in a range of about 100° C. to about 300° C. or about 100° C. to about 250° C., and a time duration in a range of about 2 hours to about 24 hours or about 6 hours to about 18 hours.

In some embodiments, reacting in (2) includes adding or otherwise incorporating the M-containing precursor, the Pt-containing precursor (which can be the same as or different from the Pt-containing precursor used in (1)) and the Ni-containing precursor (which can be the same as or different from the Ni-containing precursor used in (1)) to the liquid medium. Suitable M-containing precursors include an organometallic coordination complex of M with an organic anion, such as carbonyl. Multiple different dopant-containing precursors can be used, such as to form nanostructures doped with two or more doping elements. Reaction can be carried out under agitation and under conditions of a temperature in a range of about 100° C. to about 300° C. or about 100° C. to about 250° C., and a time duration in a range of about 12 hours to about 60 hours or about 24 hours to about 60 hours.

FIG. 21 is a schematic of a fuel cell 100 according to an embodiment of this disclosure. The fuel cell 100 includes an anode 102, a cathode 104, and an electrolyte 106 that is disposed between the anode 102 and the cathode 104. In the illustrated embodiment, the fuel cell 100 is a PEM fuel cell, in which the electrolyte 106 is implemented as a proton-exchange membrane, such as one formed of polytetrafluoroethylene or other suitable fluorinated polymer. During operation of the fuel cell 100, a fuel (such as hydrogen or an alcohol) is oxidized at the anode 102, and oxygen is reduced at the cathode 104. Protons are transported from the anode 102 to the cathode 104 through the electrolyte 106, and electrons are transported over an external circuit load. At the cathode 104, oxygen reacts with the protons and the electrons, forming water and producing heat. Either one, or both, of the anode 102 and the cathode 104 can include an electrocatalyst as set forth in this disclosure. For example, the cathode 104 can include a transition metal-doped Pt—Ni catalyst.

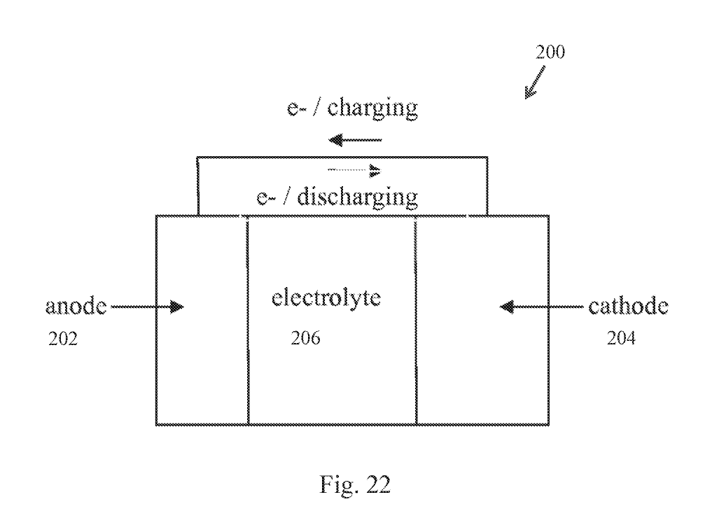

FIG. 22 is a schematic of a metal-air battery 200 according to an embodiment of this disclosure. The battery 200 can operate based on oxidation of lithium at an anode 202 and reduction of oxygen at a cathode 204 to induce a current flow. In the case of a Li-air battery, the anode 202 includes lithium metal, although other metals (e.g., zinc) can be included in place of, or in combination with, lithium metal. An electrolyte 206 is disposed between the anode 202 and the cathode 204, and can be an aprotic electrolyte, although other types of electrolytes are contemplated, such as aqueous, solid state, and mixed aqueous/aprotic electrolytes. The cathode 204 can include an electrocatalyst as set forth in this disclosure. For example, the cathode 204 can include a transition metal-doped. Pt—Ni catalyst.

### EXAMPLE

The following example describes specific aspects of some embodiments of this disclosure to illustrate and provide a description for those of ordinary skill in the art. The example should not be construed as limiting this disclosure, as the example merely provides specific methodology useful in understanding and practicing some embodiments of this disclosure.

### High-performance Transition Metal-Doped Pt₃Ni Octahedra for Oxygen Reduction Reaction

Because surface and near-surface features of a catalyst can have a strong influence on its catalytic performance, this example sets forth a surface engineering strategy to further enhance the performance of Pt₃Ni(111) nanocatalysts. Efforts focused on Pt₃Ni-based nanocatalysts because the bulk extended Pt₃Ni(111) surface is one of the most efficient catalytic surfaces for oxygen reduction reaction (ORR). On the basis of the control over dopant incorporation of various transition metals onto the surface of dispersive and octahedral Pt₃Ni/C (termed as M-Pt₃Ni/C, where M=V, Cr, Mn, Fe, Co, Mo, W, or Re), ORR catalysts are developed which exhibit both high activity and stability. In particular, Mo—Pt₃Ni/C catalyst of this example has high specific activity (about 10.3 mA/cm²), high mass activity (about 6.98 A/mg_{Pt}), and substantially improved stability for about 8000 potential cycles.

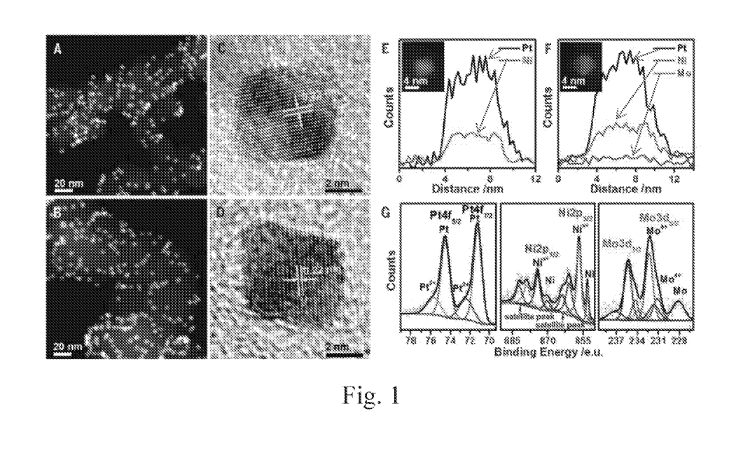

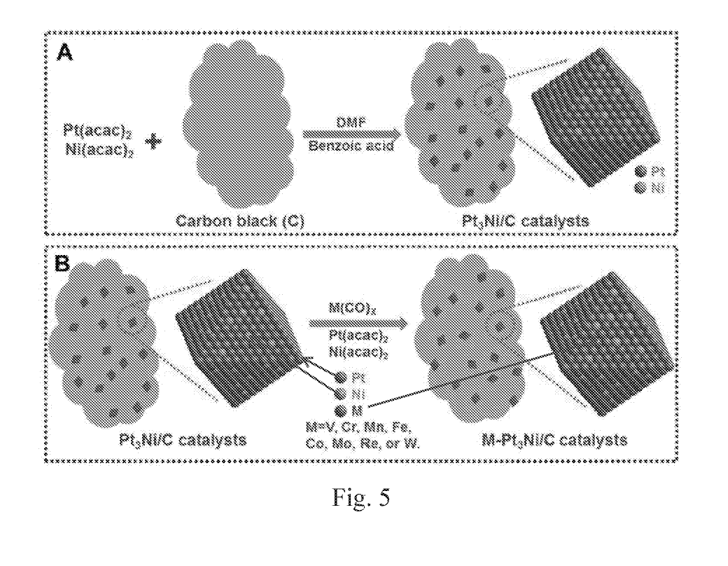

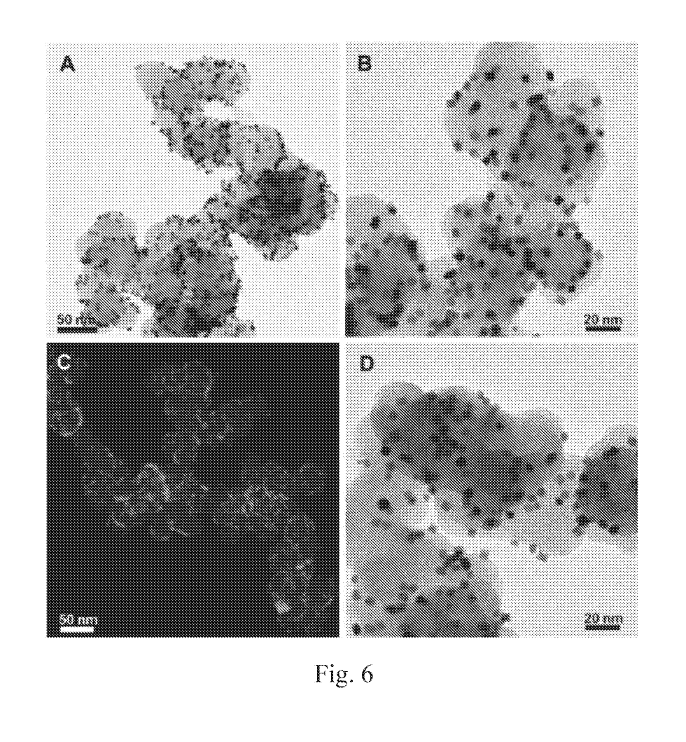

Highly dispersed Pt₃Ni octahedra on carbon black was prepared by an efficient one-pot approach without using any bulky capping agents, which used platinum(II) acetylacetonate [Pt(acac)₂] and nickel(II) acetylacetonate [Ni(acac)₂] as metal precursors, carbon black as support, N,N-dimethylformamide (DMF) as solvent and reducing agent, and benzoic acid as a structure-directing agent (FIG. 5A). The surface doping for the Pt₃Ni/C catalyst was initiated by the addition of dopant precursors, Mo(CO)₆, together with Pt(acac)₂ and Ni(acac)₂ into a suspension of Pt₃Ni/C in DMF, and the subsequent reaction at about 170° C. for about 48 hours (FIG. 5B). The transmission electron microscopy (TEM) and high-angle annular dark-field scanning TEM (HAADF-STEM) images of the Pt₃Ni/C and Mo—Pt₃Ni/C catalysts (FIGS. 1A and B and FIG. 6) revealed highly dispersive octahedral nanocrystals (NCs) in both samples, which were substantially uniform in size, averaging 4.2±0.2 nm in edge length. High-resolution TEM (HRTEM) images taken from individual octahedra showed a single-crystal structure with well-defined fringes (FIGS. 1C and D) and an edge lattice spacing of about 0.22 nm, which is consistent with that of face-centered cubic (fcc) Pt₃Ni.

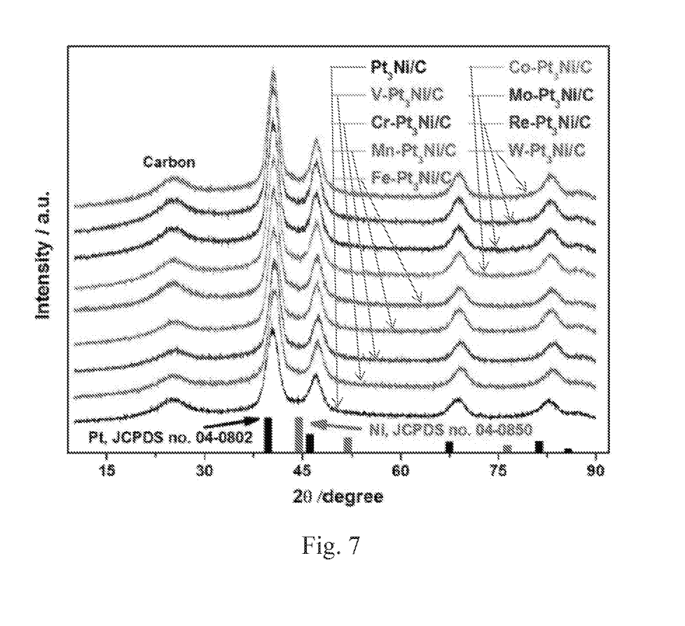

For Pt₃Ni, powder x-ray diffraction (PXRD) patterns of the colloidal products displayed peaks that could be indexed as those of fcc Pt₃Ni (FIG. 7), and the Pt/Ni composition of about 74/26 was confirmed by both inductively coupled plasma atomic emission spectroscopy (ICP-AES) and TEM energy-dispersive x-ray spectroscopy (TEM-EDS) (FIG. 8 and Table 2). Composition line-scan profiles across octahedra obtained by HAADF-STEM-EDS for Pt₃Ni/C (FIG. 1E) and Mo—Pt₃Ni/C (FIG. 1F) showed that all elements were distributed throughout the NCs (FIGS. 1E and F). For the doped NCs, x-ray photoelectron spectroscopy (XPS) shows the presence of Pt, Ni, and Mo in the catalyst (FIG. 1G). The Ni 2p and Pt 4f XPS spectra of the Mo—Pt₃Ni/C catalyst showed that the majority of the surface Ni was in the oxidized state and that the surface Pt was mainly in the metallic state. Mo exhibits mainly Mo⁶⁺ and Mo⁴⁺ states. The overall molar ratio for Pt, Ni, and Mo obtained from ICP-AES was about 73.4:25.0:1.6.

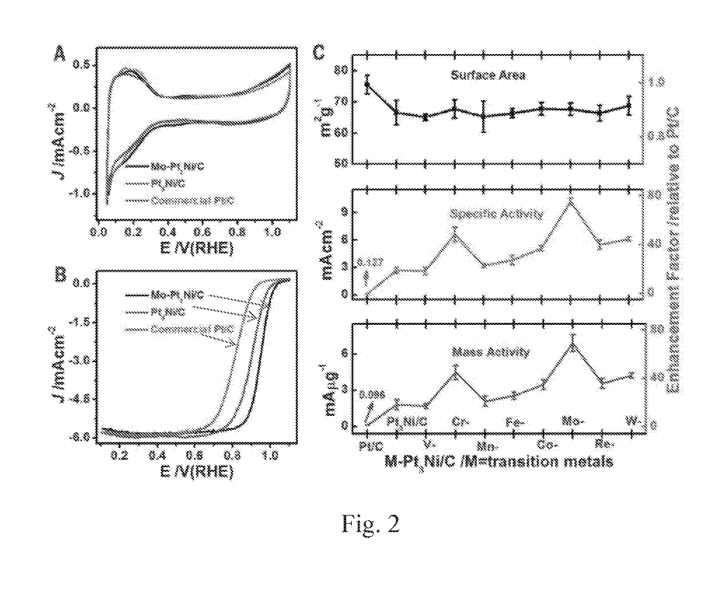

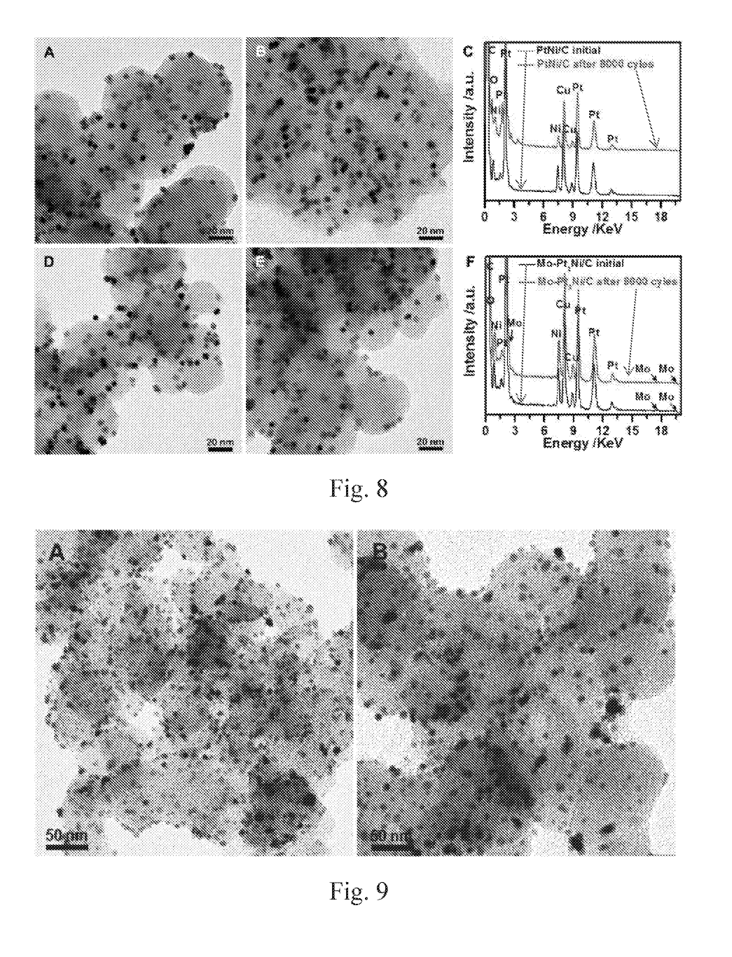

To assess ORR catalytic activity, cyclic voltammetry (CV) was used to evaluate the electrochemically active surface areas (ECSAs). The catalysts were loaded (with the same Pt mass loading) onto glassy carbon electrodes. A commercial Pt/C catalyst [20 weight percent (wt. %) Pt on carbon black; Pt particle size, about 2 to about 5 nm] obtained from Alfa-Aesar was used as a baseline catalyst for comparison (FIG. 9). The CV curves on these different catalysts are compared in FIG. 2A. The ECSA. is calculated by measuring the charge collected in the hydrogen adsorption/desorption region (between about 0.05 and about 0.35 V) after double-layer correction and assuming a value of about 210 mC/cm² for the adsorption of a hydrogen monolayer. The octahedral Pt₃Ni/C and Mo—Pt₃Ni/C catalysts display similar and high ECSAs of about 66.6 and about 67.5 m²/g_{Pt}, respectively, which is comparable with that of the commercial Pt/C catalyst (about 75.6 m²/g_{Pt}) (FIG. 2C, top).

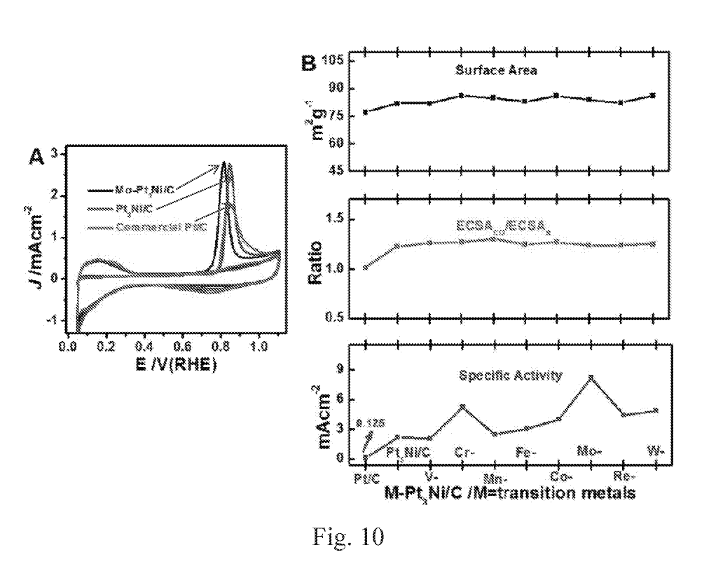

The ORR polarization curves for the different catalysts, which were normalized by the area of the glassy carbon area (about 0.196 cm²), are shown in FIG. 2B. The polarization curves display two distinguishable potential regions: the diffusion-limiting current region below about 0.6 V and the mixed kinetic-diffusion control region between about 0.6 and about 1.1 V. The kinetic currents are calculated from the ORR polarization curves by considering the mass transport correction. In order to compare the activity for different catalysts, the kinetic currents were normalized with respect to both ECSA and the loading amount of metal Pt. As shown in FIG. 2C, the octahedral Mo—Pt₃Ni/C exhibits a specific activity of about 10.3 mA/cm² at about 0.9 V versus a reversible hydrogen electrode (RHE). In contrast, the specific activity of the undoped Pt₃Ni./C catalyst is about 2.7 mA/cm². On the basis of the mass loading of Pt, the mass activity of the Mo—Pt₃Ni/C catalyst was calculated to be about 6.98 A/mg_{Pt}. The specific activity of the Mo—Pt₃Ni/C catalyst represents an improvement by a factor of about 81 relative to the commercial PVC catalyst, whereas the mass activity of the Mo—Pt₃Ni/C catalyst achieved an about 73-fold enhancement. To compare the activities of the catalysts of this example with the state-of-the-art reported Pt-Ni catalysts, the catalytic activities of the catalysts are calculated at about 0.95 V and with the ECSA calculated with the CO stripping method. Whether calculated at about 0.90 or about 0.95 V or the ECSA used was based on Hupd and/or CO stripping, both the specific activity and the mass activity of the Mo—Pt₃Ni/C (FIG. 10) are higher than those of the state-of-the-art Pt—Ni catalysts, including Pt—Ni nanoframes catalyst (Table 1 and Table 3).

TABLE 1
Performance of Mo—Pt₃Ni/C catalyst and representative results
of other Pt—Ni catalysts.

| | | | Based on H_{upd} | | | | Based on CO stripping | | |
|---|---|---|---|---|---|---|---|---|---|
| | | | Specific | | | | | Specific | |
| | | | activity | | Mass activity | | | activity | |
| | | | (mA/cm²) | | (A/mg_{Pt}) | | | (mA/cm²) | |
| | | ECSA | @ | @ | @ | @ | | @ | @ |
| | | (m²/ | 0.95 | 0.9 | 0.9 | 0.95 | ECSA | 0.9 | 0.95 |
| | Catalyst | g_{Pt}) | V | V | V | V | (m²/g_{Pt}) | V | V |
| This | Mo—Pt₃Ni/C | 67.7 | 10.3 | 2.08 | 6.98 | 1.41 | 83.9 | 8.2 | 1.74 |
| work | | | | | | | | | |
| This | Pt₃Ni/C | 66.6 | 2.7 | 0.55 | 1.80 | 0.33 | 81.9 | 2.2 | 0.45 |
| work | | | | | | | | | |
| | PtNi/C | 50 | 3.14 | NA | 1.45 | NA | NA | NA | NA |
| | PtNi/C | 48 | 3.8 | NA | 1.65 | NA | NA | NA | NA |
| | PtNi_{2.5}/C | 21 | NA | NA | 3.3 | NA | 31 | NA | NA |
| | Pt₃Ni/C nanoframes | NA | NA | NA | 5.7 | 0.97 | NA | NA | 1.48 |

NA: not available.

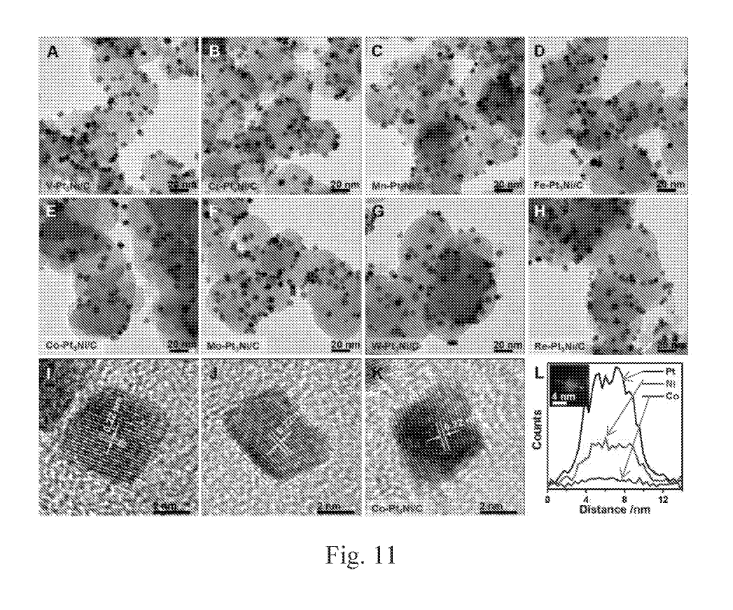

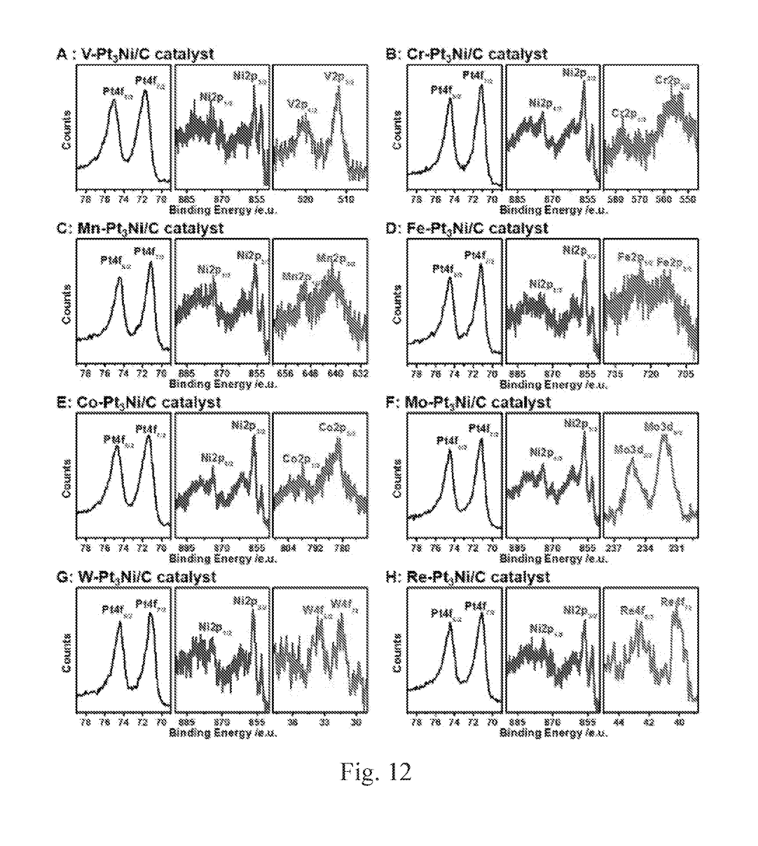

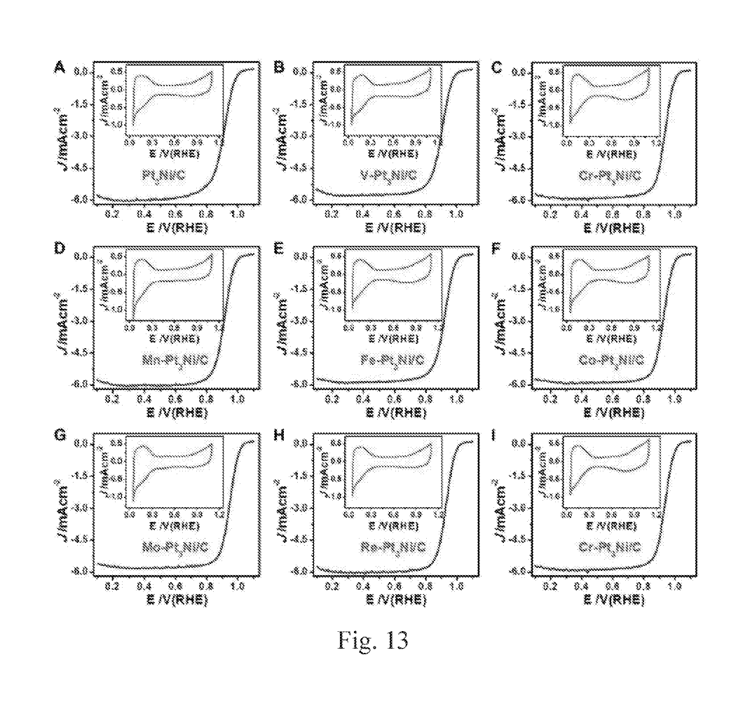

Because Mo—Pt₃Ni/C exhibited an exceptional activity toward ORR, further examination was made of the doping effects for Pt₃Ni/C modified by other transition metals. Pt₃Ni/C catalysts doped with seven other transition metals—V, Cr, Mn, Fe, Co, W, or Re—were synthesized in a similar fashion with metal carbonyls (FIGS. 11 and 12 and Table 2, details in the Materials and Methods section), and their catalytic activity toward the ORR was tested under the same conditions (FIG. 2C; individual sample measurements in FIG. 13). The ECSAs of these transition metal-doped Pt3Ni/C catalysts were all similar (FIG. 2C, top), but variable ORR activities were observed for differently doped. Pt₃Ni/C catalysts. For this example, the other dopants did not result in a catalyst with activity as high as that of Mo—Pt3Ni/C (FIG. 2C, middle). The change of mass activities in various M-doped Pt₃Ni/C catalysts was also similar to that of the specific activities (FIG. 2C, bottom), with Mo—Pt₃Ni/C showing the highest activity.

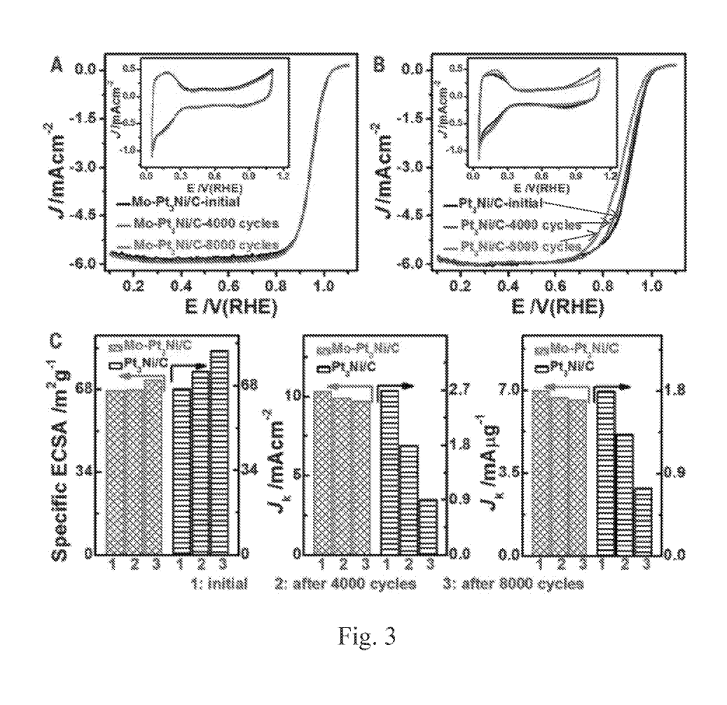

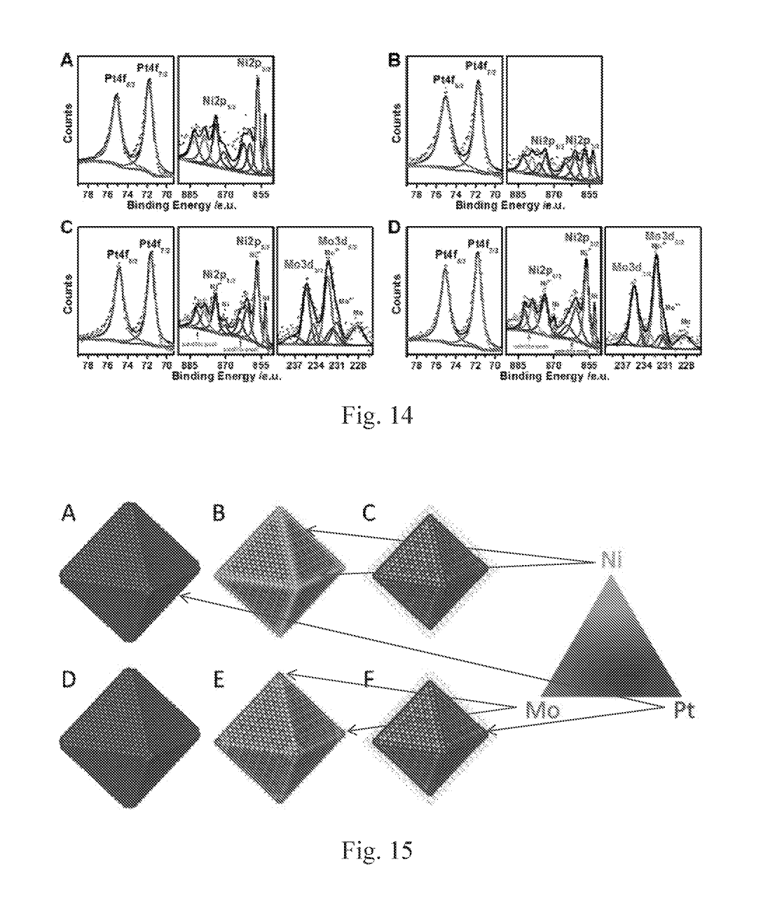

Further evaluation was made of the electrochemical durability of the Mo—Pt₃Ni/C catalyst using the accelerated durability test (ADT) between about 0.6 and about 1.1 V (versus RHE, 4000 and 800 cycles) in O₂-saturated about 0.1 M HClO₄ at a scan rate of about 50 mV/s. The Pt₃Ni/C catalyst was used as a baseline catalyst for comparison. After 4000 and 8000 potential cycles, the Mo—Pt₃Ni/C catalyst largely retained its ECSA and activity (FIG. 3A), exhibiting just about 1- and about 3-mV shifts for its half-wave potential, respectively. And after 8000 cycles, the activity of the Mo—Pt₃Ni/C catalyst was still as high as about 9.7 mA/cm² and about 6.6 A/mg_{Pt} (FIG. 3C), showing just about 6.2 and about 5.5% decreases from the initial specific activity and mass activity, respectively. On the other hand, the undoped Pt₃Ni/C catalyst was unstable under the same reaction conditions. Its polarization curve showed an about 33-mV negative shift after durability tests (FIG. 3B), and the Pt₃Ni/C retained just about 33 and about 41% of the initial specific activity and mass activity, respectively, after 8000 cycles (FIG. 3C). The morphology and the composition of the electrocatalysts after the durability change were further examined. As shown in FIG. 8, although the size of the Pt₃Ni/C octahedra were largely maintained, their morphologies became more spherical. This change of the morphology likely resulted from the Ni loss after the potential cycles, as confirmed by EDS and XPS analyses (the Pt/Ni composition ratio changed from about 74.3/25.7 to about 88.1/11.9) (FIGS. 8 and 14). In contrast, the corresponding morphology of the Mo—Pt3Ni/C catalyst largely maintained the octahedral shape, and the composition change was negligible (from about 73.4/25.0/1.6 to about 74.5/24.0/1.5).

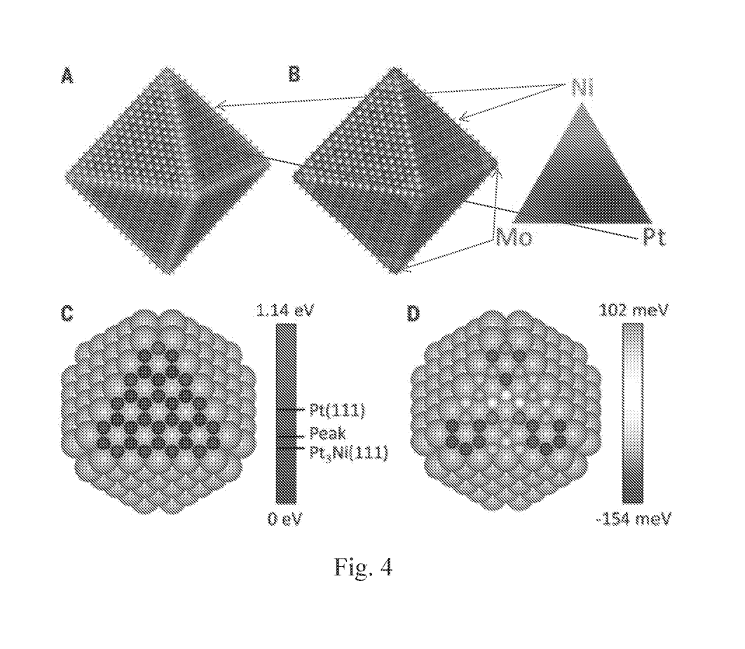

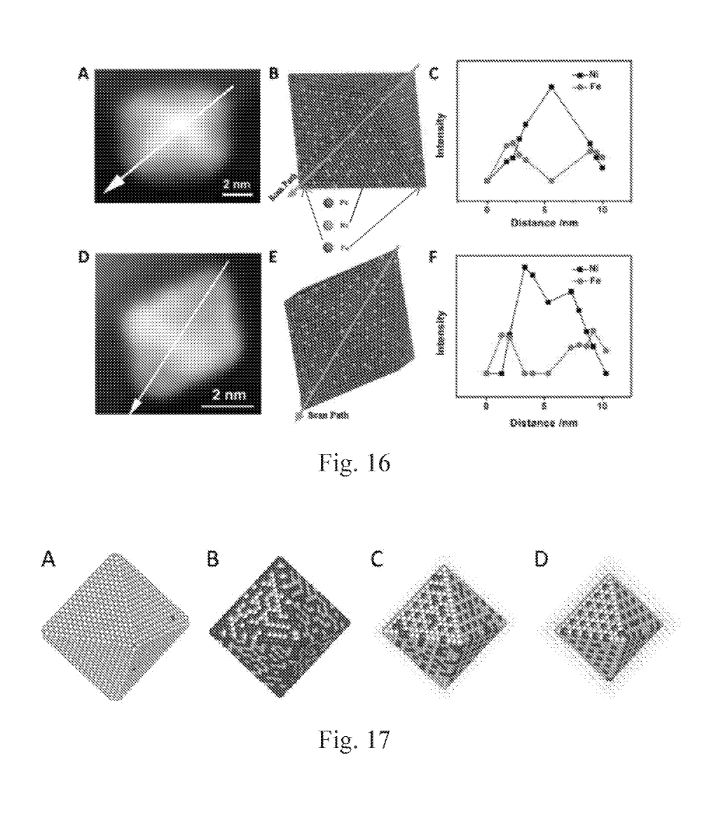

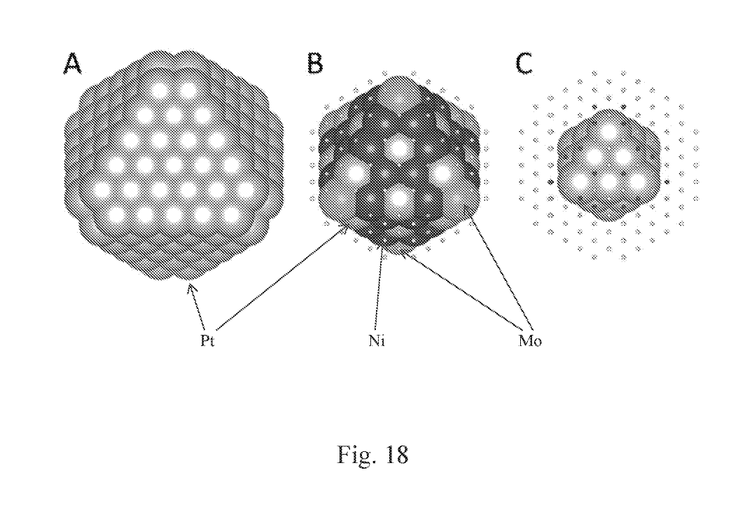

To investigate the cause of the enhanced durability of the Mo—Pt₃Ni/C catalysts, cluster expansions of Pt—Ni—Mo NCs were used in Monte Carlo simulations to identify low-energy NC and (111) surface structures for computational analysis (details of calculations are provided in the Materials and Methods section). In vacuum, the equilibrium structures predicted by the cluster expansion have a Pt skin, with Mo atoms preferring sites in the second atomic layer along the edges connecting two different (111) facets (FIGS. 4A and B and FIG. 15). Density functional theory (DFT) calculations indicate that in vacuum, the sub-surface site is preferable to the lowest-energy neighboring surface site, but in the presence of adsorbed oxygen, there is a strong driving force for Mo to segregate to the surface, where it was found to be most stable on a vertex site. This indicates the formation of surface Mo-oxide species, which is consistent with XPS measurements. The calculations indicate that the formation of surface Mo-oxide species may contribute to improved stability by “crowding out” surface Ni. The computational prediction that Mo favors sites near the particle edges and vertices is consistent with the dopant distributions for Fe shown in STEM electron energy loss spectroscopy (EELS) line scan results (FIG. 16).

The calculations indicate that doping NCs with Mo directly stabilizes both Ni and Pt atoms against dissolution and may inhibit diffusion through the formation of relatively strong Mo—Pt and Mo—Ni bonds. Calculations on a representative nanoparticle with dimensions and composition comparable with those observed experimentally (FIG. 17) indicate that a Mo on an edge or vertex site increases the energy involved to remove a Pt atom from a neighboring edge or vertex site by an average of about 362 meV, with values ranging from about 346 to about 444 meV, and to remove a Ni atom by an average of about 201 meV, with values ranging from about 160 to about 214 meV. These predictions are consistent with the ADT results. The evidence that Mo may have a stabilizing effect on under-coordinated sites indicates that Mo atoms may also pin step edges on the surface, inhibiting the dissolution process.

Although the exact mechanisms by which the surface-doped Pt₃Ni shows exceptional catalytic performance can be further evaluated, local changes in oxygen binding energies provide a possible explanation for at least some of the observed increase in specific activity, A Sabatier volcano of ORR catalysts predicts that ORR activity will be maximized when the oxygen binding energy is about 0.2 eV less than the binding energy on Pt(111). Calculations indicate that sites near the particle edge bind oxygenated species too strongly, such as in Pt(111), and sites near the facets of the particles bind oxygenated species too weakly, such as in Pt₃Ni(111) (FIG. 4C). However, compared with the undoped NC, the oxygen binding energies in the doped NC near the Mo atoms are decreased by up to about 154 meV, and binding energies at sites closer to the center of the (111) facet are increased by up to about 102 meV (FIG. 41D). Thus, if Mo migrates to the thermodynamically favored sites near the particle edges, it may shift the oxygen binding energies at these sites closer to the peak of the volcano plot. Similarly, Mo doping may increase the oxygen binding energies at sites closer to the center of the (111) facet that bind oxygen too weakly. As a result of these shifts, some sites may become highly active for catalysis. Thus, this example demonstrates that engineering the surface structure of the octahedral Pt₃Ni NC allows fine-tuning of the chemical and electronic properties of the surface layer and hence allows modulation of its catalytic activity.

Materials and Methods

Chemicals:

Platinum(II) acetylacetonate (Pt(acac)₂, about 97%), nickel(II) acetylacetonate (Ni(acac)₂, about 95%), cyclopentadienylvanadium(0) carbonyl (C₅H₅V(CO)₄, about 98%), chromium(0) hexacarbonyl (Cr(CO)₆, about 98%), dimanganese(0) decacarbonyl (Mn₂(CO)₁₀, about 98%), iron(0) pentacarbonyl (Fe(CO)₅, >about 99.99%), dicobalt(0) octacarbonyl (Co₂(CO)₈, >about 99.99%), molybdenum(0) hexacarbonyl (Mo(CO)₆, about 98%), tungsten(0) hexacarbonyl (W(CO)₆, about 97%), dirhenium(0) decacarbonyl (Re₂(CO)₁₀, about 98%), benzoic acid (C₆H₅COOH, ≥about 99.5%), and N,N-dimethylformamide (DMF, ≥about 99.9%) were all purchased from Sigma-Aldrich. All chemicals were used as received without further purification. The water (about 18 MΩ/cm) used in all experiments was prepared by passing through an ultra-pure purification system (Aqua Solutions).

Preparation of Octahedral Pt₃Ni/C Catalyst:

In a typical preparation of octahedral Pt₃Ni/C catalyst, platinum(II) acetylacetonate (Pt(acac)₂, about 8.0 mg), nickel(II) acetylacetonate (Ni(acac)₂, about 4.0 mg), benzoic acid (C₆H₅COOH, about 61 mg) and about 10 mL commercial carbon black dispersed in DMF (about 2 mg/mL, Vulcan XC72R carbon) were added into a vial (volume: about 30 mL). After the vial had been capped, the mixture was ultrasonicated for about 5 minutes. The resulting homogeneous mixture was then heated at about 160° C. for about 12 h in an oil bath, before it was cooled to room temperature. The resulting colloidal products were collected by centrifugation and washed three times with an ethanol/acetone mixture.

Preparation of Transition Metal-Doped Pt₃Ni/C Catalyst (M-Pt₃Ni/C Catalyst):

The Mo—Pt₃Ni/C catalyst was obtained by further growth of Mo on the preformed octahedral PtiNi/C catalyst. In a typical preparation of octahedral M-Pt₃Ni/C catalyst, platinum(II) acetylacetonate (Pt(acac)₂, about 2.0 mg), nickel(II) acetylacetonate (Ni(acac)₂, about 1.0 mg) and molybdenum hexacarbonyl (Mo(CO)₆, about 0.4 mg) were added to the suspension of unpurified Pt₃Ni/C catalyst prepared above. After the vial had been capped, the mixture was ultrasonicated for about 30 minutes. The resulting mixture was then heated at about 170° C. for about 48 h in an oil bath, before it was cooled to room temperature. The resulting colloidal products were collected by centrifugation and washed three times with an ethanol/acetone mixture. The surface doping approach was robust and readily extended to other metals [V, Cr, Mn, Fe, Co, W, or Re] by replacing Mo(CO)₆ with other transition metal carbonyl compounds in the above described process. In these other transition metal-doped Pt₃Ni/C catalysts, highly dispersive NCs with octahedral morphology anchored on carbon black were obtained (FIG. 11). The structures and compositions of the transition metal-doped Pt₃Ni/C catalysts were confirmed by XPS and ICP-AES, indicating similar structure and surface compositions, as shown in FIG. 12 and Table 2. The successful fabrication of various transition metal-doped Pt₃Ni/C catalysts with well-defined size, morphology and surface composition allows comparison of the doping effects for Pt₃Ni/C made by various transition metals (FIG. 2).

Characterizations:

Transmission electron microscopy (TEM) images were obtained on a FEI CM120 transmission electron microscope operated at about 120 kV, High resolution TEM images (HRTEM) and the high-angle annular dark-field scanning TEM (HAADF-STEM) and energy-dispersive X-ray spectroscopy (EDS) results were obtained on a FEI TITAN transmission electron microscope operated at about 300 kV. The STEM electron energy loss spectroscopy (EELS) tests were performed on an aberration corrected transmission electron microscope. The samples were prepared by dropping ethanol dispersion of catalysts onto carbon-coated copper TEM grids (Ted Pella, Redding, Calif.) using pipettes and dried under ambient condition. Powder x-ray diffraction (PXRD) patterns were collected on a Panalytical X'Pert Pro X-ray Powder Diffractometer with Cu—Kα radiation. X-ray photoelectron spectroscopy (XPS) tests were performed with Kratos AXIS Ultra. DLD spectrometer. The concentration of catalysts was determined by inductively coupled plasma atomic emission spectroscopy (TJA RADIAL IRIS 1000 ICP-AES).

Electrochemical Measurements:

A three-electrode cell was used to perform the electrochemical measurements. The working electrode was a glassy-carbon rotating disk electrode (RDE) (diameter: about 5 mm, area: about 0.196 cm²) from Pine Instruments. Ag/AgCl (about 3 M CF) was used as reference electrode. Pt wire was used as counter electrode. The Pt loading of octahedral M-Pt₃Ni/C and octahedral Pt₃Ni/C were about 0.8 μg (about 4.08 μg_{Pt}/cm² based on the geometric electrode area of about 0.196 cm²). The lowest mass loading of the catalyst is about 0.80 μg. The electrochemical active surface area (ECSA) measurements were determined by integrating the hydrogen adsorption charge on the cyclic voltammetry (CV) scans at room temperature in nitrogen saturated about 0.1 M HClO₄ solution. The potential scan rate was about 100 mV/s for the CV measurement. Oxygen reduction reaction (ORR) measurements were conducted in oxygen saturated about 0.1 M HClO₄ solution which was purged with oxygen during the measurement. The scan rate for ORR measurement was about 10 mV/s. The ORR polarization curves were collected at about 1600 rpm. The accelerated durability tests (ADTs) were performed at room temperature in oxygen saturated about 0.1 M HClO₄ solutions by applying cyclic potential sweeps between about 0.6 and about 1.1 V versus reversible hydrogen electrode (RHE) at a sweep rate of about 50 mV/s for 8000 cycles. For comparison, commercial Pt/C catalyst (Alfa Aesar, about 20 wt. % Pt, Pt particle size: about 2-5 nm) was used as the baseline catalyst, the same procedure as described above was used to conduct the electrochemical measurement, and the Pt loading was about 4.08 μg_{Pt}/cm² for the commercial Pt/C catalyst.

Density Functional Theory (DFT) Calculations:

DFT calculations were performed using the Vienna Ab-initio Software Package (VASP) with the revised. Perdew-Burke-Eznerhof (RPBE) exchange-correlation functional. All DFT calculations were run with spin-polarization activated. The Mo_pv, Ni, Pt_pv_GW, O_GW, and H_GW PBE projector-augmented wave (PAW) potentials provided with VASP were used, and VASP was run with high precision. A single k-point at the center of the Brillouin zone was used for each nanoparticle. For bulk materials, a 16×16×16 k-point grid was used for a fcc unit cell, and the k-point grid was scaled appropriately for larger cells. Second-order Methfessel-Paxton smearing with a width of 0.2 eV was used to set partial occupancies. Real-space projectors were used to evaluate the non-local part of the PAW potential. Calculations were stopped when the difference for the total energy in successive ionic relaxation steps was less than 1 meV. The surface d-band centers were calculated using the site-projected densities of states for surface atoms.

Cluster Expansion:

Cluster expansions are parameterized models that can be used to rapidly and accurately predict the energies of different arrangements of atoms and vacancies on a lattice of sites. Here, a single cluster expansion is used to predict the energies of nanoparticles as a function of shape, size, and internal atomic order. A quaternary cluster expansion was generated on an fcc lattice in which each site could be occupied by molybdenum, nickel, platinum, or a vacancy. Site variable values of 0, 1, 2, and 3 respectively were assigned to these species. A discrete cosine basis was used to generate the cluster functions, where the b^{th} basis function of the site variables is given by

$${Θ}_{b} = \{ \begin{matrix}0 & for b = 0 \\ \sqrt{2} cos ( π b ( 2 s + 1 ) / 8 ) & for b > 0\end{matrix} for b ∈ \{ 0 , 1 , 2 , 3 \} .$$

To create the initial 136 structures used for the training data, a “dummy” cluster expansion was generated, composed of just nearest-neighbor pair clusters, with effective cluster interactions (ECIs) chosen in a way that assigned a value of −1 eV to atom-atom interactions (regardless of the species involved) and no energy to other interactions. These cluster expansions were used in Monte Carlo simulations at 2000 4500 K to generate random snapshots of nanoparticles. Two different sets of random nanoparticles were created. The first set of nanoparticles contained just Ni and Pt, where the numbers of Pt and Ni atoms were independently and randomly selected from a uniform distribution over all integers from 0 to 100. The second set of nanoparticles contained Mo, Ni, and Pt, where the numbers of Mo, Ni, and Pt atoms were independently and randomly selected from uniform distributions over integers from 0 to 10, 0 to 50, and 0 to 150 respectively. All nanoparticles were generated under the constraint that there had to be more than 85 total atoms in the nanoparticle, as the inclusion of smaller particles was found to lead to cluster expansions with poor predictive accuracy for multi-nanometer nanoparticles (potentially due to quantum size effects). Nanoparticles that experienced significant reconstruction upon relaxation, specified as an atom traveling more than 75% of the nearest-neighbor distance from its initial site, were excluded. These particles accounted for about 20% of the random structures generated. All nanoparticles were contained in a cubic cell with a lattice parameter of 28.8 Å. The resulting set of random nanoparticles included 74 Ni—Pt nanoparticles and 62 Mo—Ni—Pt nanoparticles. In addition to these structures, the training data was composed of the pure elements Mo, Ni, and Pt in a bulk fcc crystal, vacuum (a lattice containing just vacant sites), and various low-energy structures predicted over the course of evaluation of this example, for a total of 195 unique structures, To reduce the prediction error of the cluster expansion, the pure elements and vacuum were included twice in the training set, and the ECIs were fit to the DFT-calculated formation energies of fully relaxed nanoparticles relative to these reference states.

The cluster expansion included the empty cluster, the one-body (point) cluster, all 2-body clusters up to the 10^{th}-nearest neighbor, all 3-body clusters up to the third-nearest neighbor, and all 4-, 5-, and 6-body clusters up to the second-nearest neighbor, for a total of 374 symmetrically distinct cluster functions. The ECIs for these cluster functions were fit to the training data using the Bayesian approach with a multivariate Gaussian prior distribution. The inverse of the covariance matrix for the prior, Λ, was diagonal, with elements given by

$${λ}_{αα} = \{ \begin{matrix}0 & for {n}_{a} = 0 \\ {λ}_{1} & for {n}_{a} = 1 \\ {{λ}_{2} ( 1 + {r}_{α} )}^{{λ}_{3}} {e}^{{λ}_{4} {n}_{a}} & for {n}_{a} > 1\end{matrix}$$

where n_{α} is the number of sites in cluster function α, r_{α} is the maximum distance between sites, and the parameters λ₁, λ₂, λ₃, and λ₄ were determined by using a conjugate gradient methodology to minimize the leave-one-out cross validation score, an estimate of prediction error. The final values for these parameters were 10⁻⁸, 1.102×10⁻¹², 6.103, and 4.312 respectively. The resulting cluster expansion had a root mean square leave-one-out cross validation error of 0.742 meV per site, corresponding to 3.87 meV per atom.

Sample Structures:

The cluster expansions were used in Monte Carlo simulations to calculate thermodynamic averages, identify ground state structures, and identify sample structures. The structures referenced in the text of the example include a nanoparticle with composition Mo₆Ni₄₁Pt₁₇₈, a 9-layer (111) slab with composition Mo₂Ni₇Pt₂₇, and 4573-atom nanoparticles with compositions Ni₁₁₇₅Pt₃₃₉₈ and Mo₇₃Ni₁₁₄₃Pt₃₃₅₇.

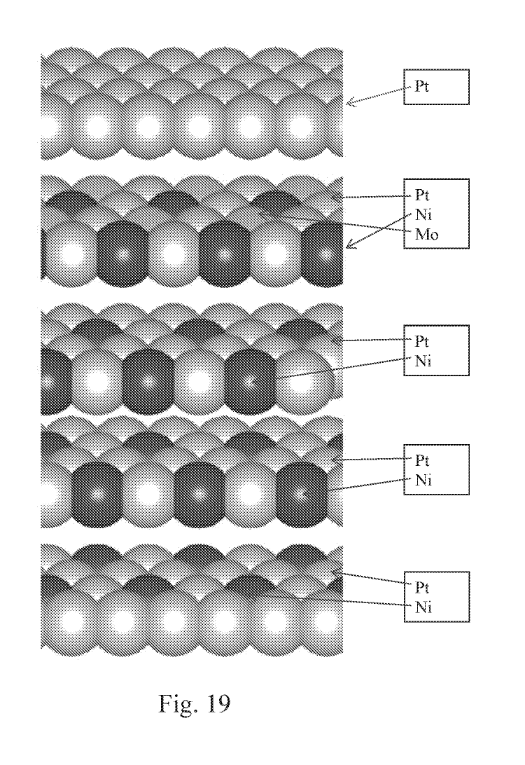

The nanoparticle with composition Mo₆Ni₄₁Pt₁₇₈ (FIG. 19) was identified by the cluster expansion as the ground state structure at this composition using a simulated annealing methodology that simultaneously optimized the particle shape and internal atomic order. Although this nanoparticle is smaller than the experimentally-observed nanoparticles, it retains salient structural features and is small enough to be modeled using density functional theory. To evaluate the chemical effects of Mo doping independent of shape/size effects, the particle was compared with an undoped particle with composition Ni₄₇Pt₁₇₈ generated by replacing the Mo atoms on sub-surface edge sites with Ni atoms.

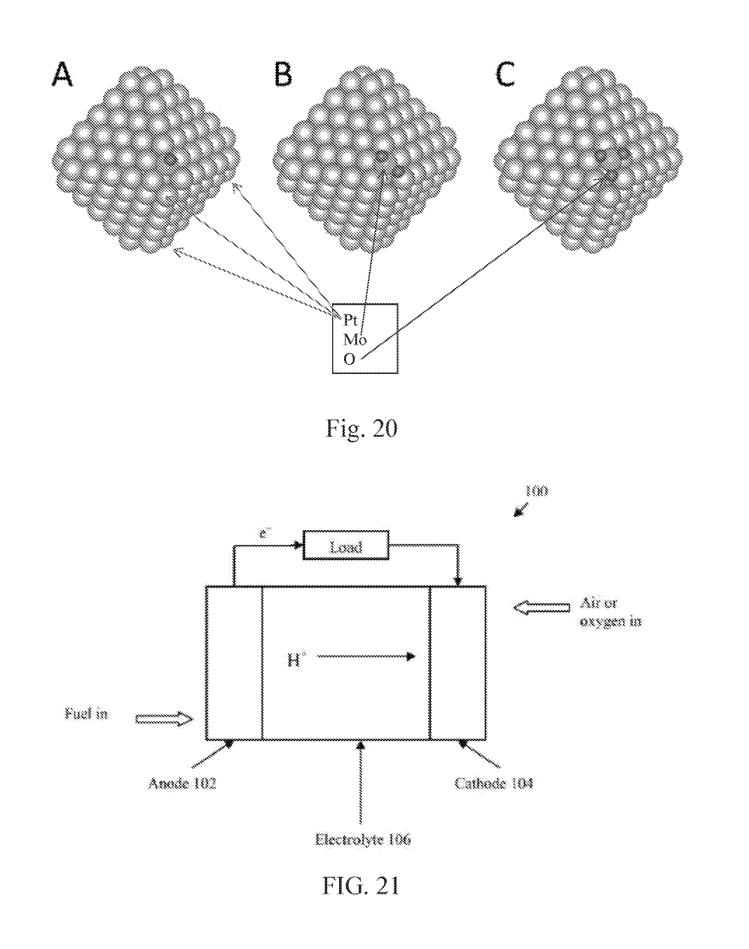

The 9-layer (111) slab with composition Mo₂Ni₇Pt₂₇ (FIG. 20) was identified by the cluster expansion as the ground-state structure at this composition. To prevent interaction between neighboring surfaces (and adsorbed molecules) in the periodic unit cell, a distance of 2.25 nm was provided between opposing surfaces. All calculations on slabs were done in a way to preserve the symmetry between the two slab surfaces.

In FIG. 4, the oxygen binding energy on the Pt₃Ni(111) surface was calculated using the ground-state 9-layer slab predicted by the cluster expansion. This structure is the same as the structure shown in FIG. 20, with Mo atoms replaced by Ni atoms. Binding energies were evaluated at all symmetrically distinct fcc and hcp sites at ¼ monolayer coverage, and the largest binding energy was used in FIG. 4. For the Pt(111) surface, the oxygen binding energy was calculated at the fcc site of a 9-layer slab at ¼ monolayer coverage.

The 4573-atom nanoparticles were created by generating octahedra with the six vertex atoms removed. The length of the remaining edges is estimated to be about 4.1 nm, consistent with nanoparticles observed experimentally. The shapes of these nanoparticles were held fixed, and just the internal atomic order was allowed to vary. The compositions of the nanoparticles were set to match the Ni_{0.257}Pt_{0.743} and Mo_{0.016}Ni_{0.25}Pt_{0.734} compositions observed experimentally. The average site occupancies of these particles at 170° C. are shown in FIG. 4, and a snapshot of a representative Ni₁₁₇₅Pt₃₃₉₈ particle at 170° C. is shown in FIG. 17.

The most favorable site for Mo surface segregation in the presence of an adsorbed oxygen atom for the Mo₆Ni₄₁Pt₁₇₈ particle was determined by evaluating Mo segregation to each of the nearest face, vertex, and edge sites for each of the symmetrically distinct Mo atoms. In each case, the adsorbed oxygen atom was placed atop the surface Mo atom, as calculations indicate that this is the most favorable site for oxygen adsorption.

Surface Segregation:

To assess the energetics of surface segregation, DFT calculations were performed on both the extended (111) slab and the Mo₆Ni₄₁Pt₁₇₈ particle. For the clean slab in vacuum, Mo is more stable at a subsurface site than the lowest-energy surface site by 0.881 eV per Mo atom. For the nanoparticle in vacuum, the subsurface site is favored over the lowest-energy neighboring surface site by 1.110 eV. The situation reverses in the presence of oxygen. In the presence of adsorbed oxygen on the (111) surface (with ¼ monolayer coverage), there is a driving force of 1.559 eV per Mo atom for Mo to segregate to the surface, and the oxygen preferentially adsorbs atop the surface Mo atom. For the Mo₆Ni₄₁Pt₁₇₈ nanoparticle, similar results were found: in the presence of an adsorbed oxygen atom Mo preferentially segregates to a vertex site, and the driving force for this segregation is 1.533 eV. The Mo₆Ni₄₁Pt₁₇₈ nanoparticle with a single Mo atom segregated to the energetically-preferred vertex site was used to assess the stability of surface Mo-oxide species against reduction to H₂O. The structures used in these calculations, composed of one, two, and three oxygen atoms adsorbed on the vertex Mo atom, are shown in FIG. 21. The computational hydrogen electrode model was used to calculate stability, where the energies of H₂O, H₂, and the nanoparticle were calculated using DFT. Zero-point energies were calculated in the harmonic approximation using and the finite differences method. The slab with Mo segregated to the surface was used to estimate the zero point energy for 0 adsorbed atop a Mo atom, where the positions of the atoms in the slab were held fixed. Gas-phase free energies for H₂ and H₂O were taken from reported values. The adsorbed O was calculated to be stable against reduction to H₂O down to potentials of 0.6 V (for the first atom removed), 0.3 V (for the second atom), and −1.0 V (for the third atom) vs. the RHE.

Due to the relatively strong Mo—Pt and Ni—Pt nearest-neighbor bonds, both Mo and Ni prefer to occupy similar sites with many Pt nearest neighbors. However in oxidizing conditions, the energetic driving force for Mo segregation to the surface is much stronger than the driving force for Ni segregation. For the Mo₂Ni₇Pt₂₇ slab with ¼ monolayer oxygen coverage, the calculated driving force for 2nd-layer Mo to migrate to the surface is 1.559 eV per atom, as opposed to 0.284 eV per atom for Ni. This indicates that in oxidizing conditions Mo atoms may “crowd out” Ni atoms on the particle surface, reducing the number of surface Ni atoms available for dissolution.

Stability Enhancements:

The cluster expansion was used to evaluate the effects of substituting a single Mo atom into all the sites in the representative Ni₁₁₇₅N₃₃₉₈ particle (FIG. 17). The presence of a Mo atom increases the energy involved to remove a Pt atom from a neighboring surface site by an average of about 377 meV, with values ranging from about 180 to about 491 meV depending on the local atomic structure. The energy involved to remove a Ni atom from a neighboring surface site increases by an average of about 240 meV, with values ranging from about 81 to about 338 meV. The smallest increase in the energy involved to remove surface Pt (about 180 meV) was observed to occur for a Pt atom at a face site, with a Mo atom in the second layer beneath it. The greatest increase in the energy involved to remove surface Pt (about 491 meV) was also observed to occur for a Pt atom at a face site, with a Mo atom in the second layer beneath it. The smallest increase in the energy involved to remove surface Ni (about 81 meV) was observed to occur for a Ni atom at a face site, with a Mo atom in the layer beneath it. The greatest increase in the energy involved to remove surface Ni (about 338 meV) was observed to occur for a Ni atom at a non-vertex edge site, with a Mo atom in the layer beneath it.

If the Mo atom is on an edge or vertex site, the energy involved to remove a Pt (Ni) atom from a neighboring edge or vertex site increases by an average of about 362 (about 201) meV, with values ranging from about 346 (about 160) to about 444 (about 214) meV. These values are supported by DPT calculations on the Mo₆Ni₄₁Pt₁₇₈ nanoparticle which predict that the presence of a Mo atom on a vertex site stabilizes the Pt atom on the neighboring vertex site by about 458 (about 444) meV with (without) an oxygen atom adsorbed atop the Mo atom. The smallest increase in the energy involved to remove Pt from an edge or vertex site (about 346 meV) was observed to occur with the Mo atom at a non-vertex edge site, with the Pt atom on a neighboring non-vertex edge site, The greatest increase in the energy involved to remove Pt from an edge or vertex site (about 444 meV) was observed to occur with the Mo atom at a vertex site and the Pt atom on a neighboring vertex site. The smallest increase in the energy involved to remove Ni from an edge or vertex site (about 160 meV) was observed to occur with the Mo atom at a vertex site, with the Ni atom on a neighboring non-vertex edge site. The greatest increase in the energy involved to remove Ni from an edge or vertex site (about 214 meV) was observed to occur with the Mo atom at a non-vertex edge site and the Ni atom on a neighboring non-vertex edge site.

The effects of second- and third-nearest-neighbor interactions were also investigated, If the Mo atom is on an edge or vertex site, the energy involved to remove a Pt (Ni) atom from a second-nearest-neighbor site on an edge or vertex increases by an average of about 3 (about −15) meV, with values ranging from 0 (about −21) to about 21 (about −6) meV. If the Mo atom is on an edge or vertex site, the energy involved to remove a Pt (Ni) atom from a third nearest-neighbor site on an edge or vertex increases by an average of about −16 (about −3) meV, with values ranging from about −42 (about −26) to about 17 (about 39) meV.

TABLE 2
Composition distribution for various transition metal-doped
Pt₃Ni/C catalysts.

| | | Composition/molar % | | |
|---|---|---|---|---|
| | Catalyst | Pt | Ni | M |
| 1 | Pt₃Ni/C | 74.2 ± 0.8 | 25.8 ± 0.7 | 0 |
| 2 | V—Pt₃Ni/C | 73.9 ± 0.6 | 24.7 ± 0.8 | 1.4 ± 0.2 |
| 3 | Cr—Pt₃Ni/C | 74.2 ± 0.5 | 24.1 ± 0.4 | 1.7 ± 0.4 |
| 4 | Mn—Pt₃Ni/C | 74.4 ± 0.7 | 24.1 ± 0.6 | 1.5 ± 0.3 |
| 5 | Fe—Pt₃Ni/C | 73.7 ± 0.4 | 24.4 ± 0.5 | 1.9 ± 0.5 |
| 6 | Co—Pt₃Ni/C | 73.5 ± 0.9 | 24.7 ± 0.8 | 1.8 ± 0.5 |
| 7 | Mo—Pt₃Ni/C | 73.9 ± 0.5 | 24.5 ± 0.5 | 1.6 ± 0.4 |
| 8 | W—Pt₃Ni/C | 74.3 ± 0.6 | 24.2 ± 0.3 | 1.5 ± 0.5 |
| 9 | Re—Pt₃Ni/C | 74.5 ± 0.4 | 23.9 ± 0.7 | 1.6 ± 0.3 |

As used herein, the singular terms “a,” “an,” and “the” include plural referents unless the context clearly dictates otherwise. Thus, for example, reference to an object can include multiple Objects unless the context clearly dictates otherwise.

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to +1%, less than or equal to +0.5%, less than or equal to ±0.1%, or less than or equal to ±0.05%.

As used herein, the terms “connect,” “connected,” and “connection” refer to an operational coupling or linking. Connected objects can be directly coupled to one another or can be indirectly coupled to one another, such as via another set of objects.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable properties that are substantially the same as those of the non-spherical object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

While the disclosure has been described with reference to the specific embodiments thereof, it should be understood by those skilled in the art that various changes may be made and equivalents may be substituted without departing from the true spirit and scope of the disclosure as defined by the appended claims. In addition, many modifications may be made to adapt a particular situation, material, composition of matter, method, operation or operations, to the objective, spirit and scope of the disclosure. All such modifications are intended to be within the scope of the claims appended hereto. In particular, while certain methods may have been described with reference to particular operations performed in a particular order, it will be understood that these operations may be combined, sub-divided, or re-ordered to form an equivalent method without departing from the teachings of the disclosure. Accordingly, unless specifically indicated herein, the order and grouping of the operations is not a limitation of the disclosure.

1. An electrode material comprising:
a catalyst support; and
Pt—Ni nanostructures affixed to the catalyst support,
wherein the Pt—Ni nanostructures are doped with at least one dopant M.

2. The electrode material of claim 1, wherein M is a transition metal different from Pt and Ni.

3. The electrode material of claim 1, wherein M is a transition metal selected from V, Cr, Mn, Fe, Co, Mo, W, and Re.

4. The electrode material of claim 3, wherein M is Mo or Cr.

5. The electrode material of claim 1, wherein a molar content of M in at least one of the Pt—Ni nanostructures is in a range of about 0.5% to about 5%.

6. The electrode material of claim 1, wherein a molar content of M in at least one of the Pt—Ni nanostructures is in a range of about 0.5% to about 3%.

7. The electrode material of claim 1, wherein the Pt—Ni nanostructures have an average size up to about 10 nm.

8. The electrode material of claim 1, wherein the catalyst support is a carbon-based support.

9. The electrode material of claim 1, wherein the Pt—Ni nanostructures have a chemical composition represented by a formula: M_{z}-PtₓNi_{y}, wherein x>y, x>z, y>z, and x+y+z=100%.

10. The electrode material of claim 9, wherein x is in a range of about 68% to about 82%, y is in a range of about 18% to about 32%, and z is in a range of about 0.5% to about 5%.

11. The electrode material of claim 9, wherein a ratio of x to y is about 3, and z is in a range of about 0.5 to about 3.

12. The electrode material of claim 1, wherein, for at least one nanostructure of the Pt—Ni nanostructures, at least a majority, by number, of M atoms are located within a depth of 3 atomic layers from an exterior of the nanostructure.

13. A fuel cell comprising:
an anode;
a cathode; and
an electrolyte disposed between the anode and the cathode,
wherein the cathode includes the electrode material of claim 1.

14. A metal-air battery comprising:
an anode;
a cathode; and
an electrolyte disposed between the anode and the cathode,
wherein the cathode includes the electrode material of claim 1.

15. A manufacturing method comprising:
providing Pt—Ni nanostructures in a liquid medium; and
reacting a M-containing precursor, a Pt-containing precursor, and a Ni-containing precursor in the liquid medium to form M-doped Pt—Ni nanostructures,
wherein M is different from Pt and Ni.

16. The manufacturing method of claim 15, wherein providing the Pt—Ni nanostructures includes providing the Pt—Ni nanostructures affixed to a catalyst support.

17. The manufacturing method of claim 15, wherein the liquid medium includes an organic solvent as a reducing agent.

18. The manufacturing method of claim 15, wherein the M-containing precursor is an organometallic coordination complex of M with an organic anion.

19. The manufacturing method of claim 15, wherein M is a transition metal different from Pt and Ni.

20. The manufacturing method of claim 15, wherein M is a transition metal selected from V, Cr, Mn, Fe, Co, Mo, W, and Re.
